(19) United States
(12) Patent Application Publication
(10) Pub. No.: US 2025/0251283 A1
(43) Pub. Date: Aug. 7, 2025

(54) METROLOGY WITH PARALLEL SUBSYSTEMS AND MUELLER SIGNALS TRAINING

(71) Applicant: KLA Corporation, Milpitas, CA (US)

(72) Inventor: Houssam Chouaib, San Jose, CA (US)

(21) Appl. No.: 18/438,122

(22) Filed: Feb. 9, 2024

Related U.S. Application Data
(60) Provisional application No. 63/550,503, filed on Feb. 6, 2024.

(51) Int. Cl. G01J 3/28; G06N 20/00

(52) U.S. Cl. CPC G01J 3/28; G06N 20/00; G01J 2003/2836

(57) ABSTRACT

A metrology system may receive two or more measurement datasets associated with a test feature on a sample from one or more measurement sub-systems operable under two or more measurement configurations, where a respective one the two or more measurement datasets is generated with a respective one of the two or more measurement configurations. A metrology system may generate two or more intermediate metrology measurements of the test feature using two or more machine learning models, where a respective one of the two or more intermediate metrology measurements is generated using at least a portion of a respective one of the two or more measurement datasets as an input to a respective one of the two or more machine learning models. A metrology system may determine a final metrology measurement of the test feature using a weighting model based on the two or more intermediate metrology measurements.

### CROSS-REFERENCE TO RELATED APPLICATION

The present application claims the benefit under 35 U.S.C. § 119(e) of U.S. Provisional Application Ser. No. 63/550,503, filed Feb. 6, 2024, entitled METROLOGY WITH PARALLEL SUBSYSTEMS AND MUELLER SIGNALS TRAINING, naming Houssam Chouaib as inventor, which is incorporated herein by reference in the entirety.

### TECHNICAL FIELD

The present disclosure relates generally to metrology and, more particularly, to architectures for machine learning models suitable for metrology.

### BACKGROUND

Many current optical metrology applications for integrated circuit manufacturing require complex spectroscopic analysis. Further, the number of critical process steps requiring sensitive metrology is continuing to increase while the window of tolerance and the precision limits of metrology techniques are tightening significantly.

Some current optical metrology techniques rely on conventional rigorous-coupled-wave-analysis (RCWA), which has the disadvantages of a relatively long time to solution and often lacks the required robustness to adapt to process variations. RCWA based solutions further require extensive computational resources and repeating arrays.

Some current optical metrology techniques utilize machine learning algorithms to generate metrology measurements based on measured data. However, such techniques typically utilize a single machine learning model to generate metrology measurements based on the measurement signals themselves or a subset thereof as inputs. However, such techniques may suffer from limited accuracy and/or robustness to process variations due to a limited set of signals that may be analyzed or undesirable correlations in the model.

There is therefore a need to develop systems and methods to address the above deficiencies.

### SUMMARY

In embodiments, the techniques described herein relate to a metrology system, including a controller including one or more processors configured to execute program instructions causing the one or more processors to implement a metrology recipe by receiving two or more measurement datasets associated with a test feature on a sample from one or more measurement sub-systems operable under two or more measurement configurations, where a respective one the two or more measurement datasets is generated with a respective one of the two or more measurement configurations; generating two or more intermediate metrology measurements of the test feature using two or more machine learning models, where a respective one of the two or more intermediate metrology measurements is generated using at least a portion of a respective one of the two or more measurement datasets as an input to a respective one of the two or more machine learning models; and determining a final metrology measurement of the test feature using a weighting model based on the two or more intermediate metrology measurements.

In embodiments, the techniques described herein relate to a metrology system, where a respective one of the two or more machine learning models is associated with a single respective one of the two or more measurement datasets.

In embodiments, the techniques described herein relate to a metrology system, where at least one of the two or more machine learning models is associated with a single Mueller matrix element and further associated with a single respective one of the two or more measurement datasets.

In embodiments, the techniques described herein relate to a metrology system, where at least one of the two or more machine learning models is associated with a linear combination of two or more Mueller matrix elements and further associated with a single respective one of the two or more measurement datasets.

In embodiments, the techniques described herein relate to a metrology system, where the program instructions are further configured to cause the one or more processors to implement the metrology recipe by extracting two or more principal component sets from the two or more measurement datasets, where a respective one of principal component sets corresponds to a subset of a respective one of the two or more measurement datasets, where generating the two or more intermediate metrology measurements of the test feature using two or more machine learning models includes generating the two or more intermediate metrology measurements of the test feature using the two or more principal component sets as inputs to the two or more machine learning models, where a respective one of the two or more principal component sets is provided as an input to the respective one of the two or more machine learning models.

In embodiments, the techniques described herein relate to a metrology system, where the two or more principal component sets are generated using at least one of a principal component analysis or a fast Fourier Transform.

In embodiments, the techniques described herein relate to a metrology system, where at least one of the two or more machine learning models includes at least one of a linear model, a neural network model, a polynomial model, a decision tree model, or a random forest model.

In embodiments, the techniques described herein relate to a metrology system, where the weighting model includes at least one of an average of the two or more intermediate metrology measurements, a weighted average of the two or more intermediate metrology measurements, or a neural network model.

In embodiments, the techniques described herein relate to a metrology system, where the program instructions are further configured to cause the one or more processors to train the two or more machine learning models with training data.

In embodiments, the techniques described herein relate to a metrology system, where the training data includes at least one of simulated datasets or measurement datasets generated on one or more training samples with known parameters of the test feature.

In embodiments, the techniques described herein relate to a metrology system, where the one or more measurement sub-systems include at least one of a spectroscopic ellipsometer, a single-wavelength ellipsometer, an angle-resolved ellipsometer, an angle-resolved reflectometer, a spectroscopic reflectometer, a single-wavelength reflectometer, a Raman metrology tool, a laser dispersion spectroscopic reflectometry tool, a spectroscopic photoreflectance tool, a spectroscopic photoluminescence tool, an x-ray metrology tool, or a particle-based metrology tool.

In embodiments, the techniques described herein relate to a metrology system, where at least one of the two or more measurement datasets includes spectroscopic measurement data.

In embodiments, the techniques described herein relate to a metrology system, where the two or more measurement configurations include two or more illumination angles.

In embodiments, the techniques described herein relate to a metrology system, where the two or more illumination angles include two or more altitude illumination angles.

In embodiments, the techniques described herein relate to a metrology system, where the two or more illumination angles include two or more azimuth illumination angles.

In embodiments, the techniques described herein relate to a metrology system, where the final metrology measurement includes to at least one of a critical dimension (CD) measurement, a height measurement, an overlay measurement, a film thickness, or a material property.

In embodiments, the techniques described herein relate to a metrology system, where the test feature includes at least one of a patterned single-layer structure, a patterned multi-layer structure or a film stack.

In embodiments, the techniques described herein relate to a metrology system, where the test feature includes two or more sub-features, where the final metrology measurement includes measurements of the two or more sub-features.

In embodiments, the techniques described herein relate to a metrology system, where the test feature is associated with at least one of an etch process, a lithography process, or a deposition process.

In embodiments, the techniques described herein relate to a metrology system, including one or more measurement sub-systems configured to operate under two or more measurement configurations; and a controller including one or more processors configured to execute program instructions causing the one or more processors to implement a metrology recipe by receiving two or more measurement datasets associated with a test feature on a sample, where a respective one the two or more measurement datasets is generated with a respective one of the two or more measurement configurations; generating two or more intermediate metrology measurements of the test feature using two or more machine learning models, where a respective one of the two or more intermediate metrology measurements is generated using at least a portion of a respective one of the two or more measurement datasets as an input to a respective one of the two or more machine learning models; and determining a final metrology measurement of the test feature using a weighting model based on the two or more intermediate metrology measurements.

In embodiments, the techniques described herein relate to a metrology system, where the one or more measurement sub-systems include at least one of a spectroscopic ellipsometer, a single-wavelength ellipsometer, an angle-resolved ellipsometer, an angle-resolved reflectometer, a spectroscopic reflectometer, a single-wavelength reflectometer, a Raman metrology tool, a laser dispersion spectroscopic reflectometry tool, a spectroscopic photoreflectance tool, a spectroscopic photoluminescence tool, an x-ray metrology tool, or a particle-based metrology tool.

In embodiments, the techniques described herein relate to a metrology system, where a respective one of the two or more machine learning models is associated with a single respective one of the two or more measurement datasets.

In embodiments, the techniques described herein relate to a metrology system, where at least one of the two or more machine learning models is associated with a single Mueller matrix element and further associated with a single respective one of the two or more measurement datasets.

In embodiments, the techniques described herein relate to a metrology system, where at least one of the two or more machine learning models is associated with a linear combination of two or more Mueller matrix elements and further associated with a single respective one of the two or more measurement datasets.

In embodiments, the techniques described herein relate to a metrology method, including receiving two or more measurement datasets associated with a test feature on a sample from one or more measurement sub-systems operable under two or more measurement configurations, where a respective one the two or more measurement datasets is generated with a respective one of the two or more measurement configurations; generating two or more intermediate metrology measurements of the test feature using two or more machine learning models, where a respective one of the two or more intermediate metrology measurements is generated using at least a portion of a respective one of the two or more measurement datasets as an input to a respective one of the two or more machine learning models; and determining a final metrology measurement of the test feature using a weighting model based on the two or more intermediate metrology measurements.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A is a block diagram of a metrology system in accordance with one or more embodiments of the present disclosure.

FIG. 1B is a simplified schematic of an optical measurement sub-system, in accordance with one or more embodiments of the present disclosure.

FIG. 1C is a simplified schematic of an x-ray measurement sub-system, in accordance with one or more embodiments of the present disclosure.

FIG. 1D is a simplified schematic of a particle beam measurement sub-system 102, in accordance with one or more embodiments of the present disclosure.

FIG. 2 is a flow diagram depicting steps performed in a metrology method, in accordance with one or more embodiments of the present disclosure.

FIG. 3A is a schematic diagram depicting the generation of a final metrology measurement based on separate machine learning models for different measurement datasets, in accordance with one or more embodiments of the present disclosure.

FIG. 3B is a schematic diagram depicting the generation of a final metrology measurement based on separate machine learning models for different Mueller matrix elements associated with different measurement datasets, in accordance with one or more embodiments of the present disclosure.

FIG. 4 is a perspective view of a test feature of a gate-all-around recess structure, in accordance with one or more embodiments of the present disclosure.

FIG. 5A is a plot of gage repeatability and reproducibility associated with metrology measurements of the top indent of the test feature in FIG. 4, in accordance with one or more embodiments of the present disclosure.

FIG. 5B is a plot of gage repeatability and reproducibility associated with metrology measurements of the middle indent of the test feature in FIG. 4, in accordance with one or more embodiments of the present disclosure.

FIG. 5C is a plot of gage repeatability and reproducibility associated with metrology measurements of the bottom indent of the test feature in FIG. 4, in accordance with one or more embodiments of the present disclosure.

FIG. 6A is a plot of blind test bias associated with metrology measurements of the top indent of the test feature in FIG. 4, in accordance with one or more embodiments of the present disclosure.

FIG. 6B is a plot of blind test bias associated with metrology measurements of the middle indent of the test feature in FIG. 4, in accordance with one or more embodiments of the present disclosure.

FIG. 6C is a plot of blind test bias associated with metrology measurements of the bottom indent of the test feature in FIG. 4, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing a metrology measurement of a test feature based on multiple (e.g., two or more) measurement datasets generated using different measurement configurations, where separate machine learning models are utilized to generate intermediate metrology measurements based on different measurement datasets or portions thereof, and where the intermediate metrology measurements are combined to generate a final metrology measurement. The systems and methods disclosed herein may be used to determine any type of metrology measurement including, but not limited to, a critical dimension (CD) measurement, a height measurement, a film thickness measurement, an overlay measurement, or a material property measurement.

Different measurement configurations may be associated with different measurement parameters of a particular measurement tool and/or with different measurement tools. Any type of measurement tool may be used including, but not limited to, optical measurement tools (e.g., an ellipsometer, a reflectometer, a spectrometer, a laser dispersion spectroscopic reflectometry tool, a Raman metrology tool, or the like) or x-ray measurement tools. Further, different measurement configurations may be associated with parameters such as, but not limited to, different illumination incidence angles (e.g., altitude and/or azimuth incidence angles).

Such a configuration may provide high levels of accuracy and/or robustness relative to existing techniques, while also providing efficient use of computational resources. In particular, the use of multiple parallel machine learning models, each trained on measurement data associated with a specific measurement configuration may provide efficient selection of parameters of the specific measurement configuration that robustly correlate to the metrology measurement. Further, the step of combining the intermediate metrology measurements into the final metrology measurement may be easily tuned or modified in response to process variations to maintain robustness. For instance, a user may adjust or modify this step without requiring retraining of the individual machine learning models. Further, the advancements in accuracy and/or robustness enable faster training with less training data and faster convergence of the total system to a solution than existing techniques.

It is contemplated herein that the systems and methods disclosed herein may be implemented in various ways within the spirit and scope of the present disclosure.

For example, machine learning models may be trained on varied datasets. In some embodiments, a single separate machine learning model is utilized for each measurement configuration. In some embodiments, at least some of the machine learning models are associated with a particular Mueller matrix element as measured by a particular measurement configuration.

As another example, inputs to machine learning models may be varied. In some embodiments, at least some machine learning models accept raw measurement data associated with a particular measurement configuration. In some embodiments, the amount of input data is reduced to a principal component set using any suitable technique such as, but not limited to, principal component analysis (linear or non-linear) or fast Fourier Transform analysis. In this way, dimensionality reduction may be achieved where the principal components (PCs) represent a portion (e.g., a subset) of a measurement dataset providing high correlation to the metrology measurement of interest.

As another example, the intermediate metrology measurements may be combined into a final metrology measurement using any suitable technique such as, but not limited to, a linear combination (e.g., an average, a weighted average, or the like) or through an additional machine learning model.

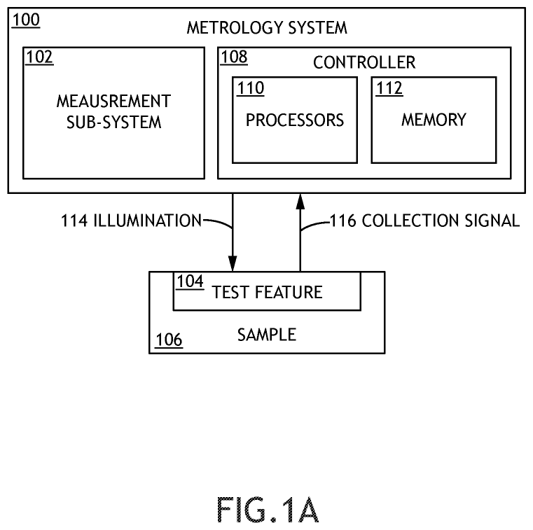

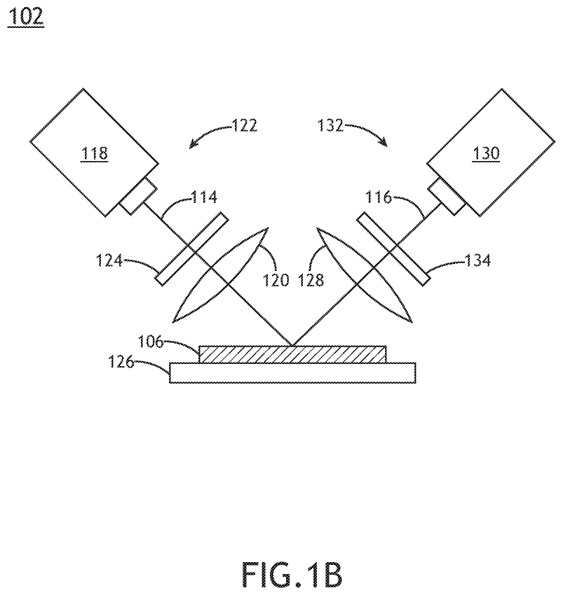

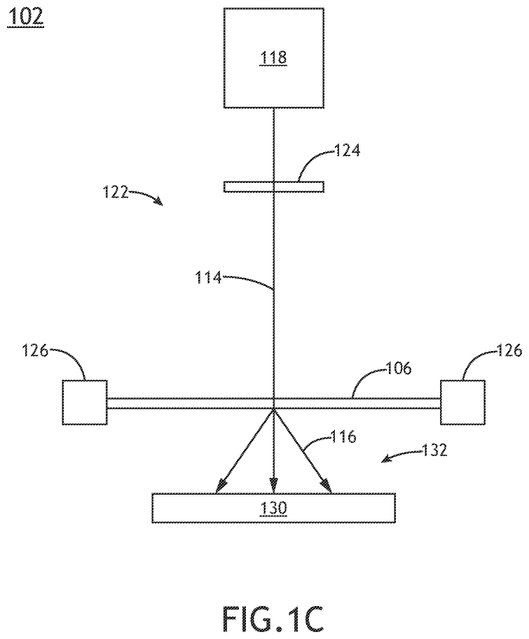

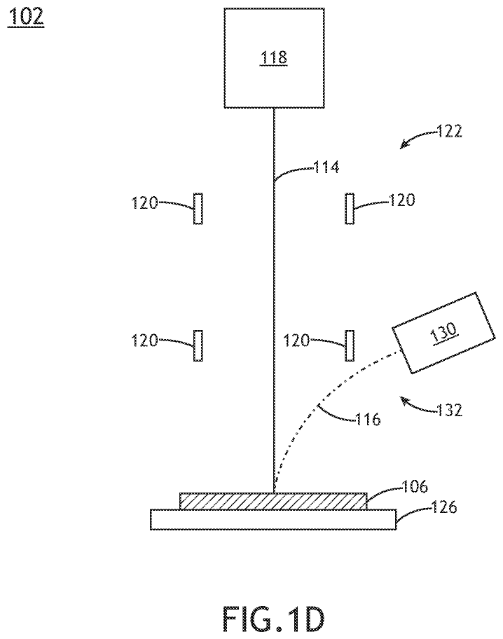

Referring now to FIGS. 1A-6C, systems and methods providing metrology measurements based on multiple parallel machine learning models are described in greater detail, in accordance with one or more embodiments of the present disclosure.

FIG. 1A is a block diagram of a metrology system 100 in accordance with one or more embodiments of the present disclosure.

In some embodiments, the metrology system 100 includes one or more measurement sub-systems 102 to generate measurement datasets of a test feature 104 on a sample 106 and further includes a controller 108 to generate one or more metrology measurements associated with the based on the measurement data. In particular, the measurement sub-systems 102 may operate under two or more measurement configurations and generate multiple (e.g., two or more measurement datasets) associated with the test feature 104 based on two or more measurement configurations. The controller 108 may include one or more processors 110 configured to execute a set of program instructions maintained in a memory 112, or memory device, where the program instructions may cause the processors 110 to implement various actions. The controller 108 may be communicatively coupled to any components of the metrology system 100 including, but not limited to, the one or more measurement sub-systems 102. In this way, the controller 108 may receive communication (e.g., data, instructions, or the like) from any connected components and/or may direct connected components (e.g., via control signals) to perform selected actions. The controller 108 may thus directly or indirectly implement any desired actions.

It is contemplated herein that the use of multiple machine learning models (e.g., operated in parallel) to generate intermediate metrology measurements and a weighting model to generate a final metrology measurement based on the intermediate metrology measurements may provide an efficient, accurate, and robust metrology technique. Notably, such a technique may outperform techniques that incorporate a single machine learning model trained on measurement data associated with multiple measurement configurations.

In particular, the various machine learning models may be separately trained and refined to provide respective metrology measurements based on measurement datasets associated with a single measurement configuration. This configuration may reduce or eliminate undesirable correlations between measurement data associated with different configurations. Since each machine learning model is based only on measurement data from a corresponding measurement condition, it can efficiently utilize a greater amount of this input data to develop robust metrology measurements. Further, the weighting model may allow for weighting of the various parallel machine learning models and noise reduction. Further, this weighting model may be tuned (e.g., in response to process variations or other drifts) to provide robust metrology without retraining the parallel machine learning models.

The measurement sub-systems 102 may include any components or combination of components suitable for generating measurement data of a test feature 104. For example, a measurement sub-system 102 may direct illumination 114 to the test feature 104 and may capture a collection signal 116 from the test feature 104 in response to the illumination 114. Measurement tools for metrology and measurement techniques are generally described in U.S. Pat. No. 10,458,912 issued on Oct. 29, 2019; U.S. Pat. No. 11,573,077 issued on Feb. 7, 2023; U.S. Pat. No. 11,036,898 issued on Jun. 15, 2021; U.S. Pat. No. 10,101,670 issued on Oct. 16, 2018; U.S. Pat. No. 10,935,893 issued on Mar. 2, 2021; U.S. Pat. No. 10,139,352 issued on Nov. 27, 2018; U.S. Pat. No. 10,152,678 issued on Dec. 11, 2018; U.S. Pat. No. 10,502,549 issued on Dec. 10, 2019; U.S. Pat. No. 9,875,946 issued on Jan. 23, 2018; U.S. Patent Publication No. 2016/0139032 published on May 19, 2016; U.S. Pat. No. 7,478,019 issued on Jan. 13, 2009; U.S. Pat. No. 7,933,026 issued on May 26, 2011; U.S. Pat. No. 5,608,526 issued on Mar. 4, 1997; U.S. Pat. No. 5,859,424 issued on Jan. 12, 1999; U.S. Pat. No. 6,429,943 issued on Aug. 6, 2002; U.S. Pat. No. 9,405,290 issued on Aug. 2, 2016; U.S. Pat. No. 9,915,522 issued on Feb. 18, 2015; U.S. Pat. No. 9,291,554 issued on Mar. 22, 2016; and U.S. Pat. No. 10,769,320 issued on Sep. 8, 2020; all of which are incorporated herein by reference in their entireties.

In some embodiments, a measurement sub-system 102 includes an optical measurement sub-system 102 to generate measurement data based on interaction of the sample 106 with illumination 114 including light of any suitable wavelength or combination of wavelengths including, but not limited to, ultraviolet (UV) wavelengths, visible wavelengths, or infrared (IR) wavelengths. For example, an optical measurement sub-system 102 may include, but is not limited to, a spectroscopic ellipsometer (SE), an SE with multiple angles of illumination, an SE measuring Mueller matrix elements (e.g. using rotating compensator(s)), a single-wavelength ellipsometer, a beam profile ellipsometer (angle-resolved ellipsometer), a beam profile reflectometer (angle-resolved reflectometer), a broadband reflective spectrometer (spectroscopic reflectometer), a single-wavelength reflectometer, an angle-resolved reflectometer, an imaging system, a scatterometer (e.g., speckle analyzer), a Raman metrology tool, a laser dispersion spectroscopic reflectometry (LDSR) tool, a spectroscopic photoreflectance tool, a spectroscopic photoluminescence tool, a second harmonic generation based tool, or any combination thereof.

In some embodiments, a measurement sub-system 102 includes an x-ray measurement sub-system 102 to generate measurement data based on interaction of the sample 106 with illumination 114 including x-rays. For example, the measurement sub-systems 102 may include, but is not limited to, a small-angle x-ray scattering (SAXS) system or an x-ray reflection scatterometry (SXR) system.

In some embodiments, a measurement sub-system 102 includes a particle-beam measurement sub-system 102 to generate measurement data based on interaction of the sample 106 with illumination 114 including a particle beam such as, but not limited to, an electron beam (e-beam), an ion beam, or a neutral particle beam.

Regardless of the configuration of a measurement sub-system 102, any type of collection signal 116 emanating from the test feature 104 in response to the illumination 114 may be captured to generate the measurement data such as, but not limited to, light (e.g., specular reflection, diffraction, scattering, luminescence, or the like), x-rays, or particles.

The different measurement configurations may be associated with different measurement sub-systems 102 and/or different configurations of any of the measurement sub-systems 102.

For example, different measurement datasets may be generated by different types of measurement sub-systems 102 (e.g., a combination of an optical measurement sub-system 102, an x-ray measurement sub-system 102, a particle-based measurement sub-system 102, or the like).

As another example, different measurement datasets may be generated by different operational parameters associated with a measurement sub-system 102. A measurement sub-system may generally be configurable according to a metrology recipe that defines a set of parameters for controlling the illumination of a sample 106 as well as the for capturing collection signal 116 from the sample 106. In this way, different measurement datasets may be associated with different configurations of a metrology recipe or different metrology recipes. For instance, different measurement configurations may be associated with different parameters of the illumination 114 and/or collection signal 116 used for a measurement such as, but not limited to, incidence angle on the sample 106 (e.g., the altitude incidence angle and/or the azimuth incidence angle), a size or distribution of the illumination 114, power, power density, energy, wavelength, or polarization.

As an illustration in a case of ellipsometery or reflectometry, different measurement conditions may be associated with different combinations of wavelength, incidence angle, or polarization for the illumination 114 and the collection signal 116. As another illustration in the case of a Raman metrology tool, different measurement configurations may be associated with different wavelengths. As another illustration in the case of a photoreflectance spectroscopy tool, different measurement configurations may be associated with different incidence angles (e.g., azimuth incidence angles) and/or polarizations of illumination 114. As another illustration in the case of a second harmonic generation tool, different measurement configurations may be associated with different wavelengths or optical power density. As another illustration in the case of an optical or x-ray measurement sub-system 102, different measurement configurations may be associated with different combinations of wavelength or polarization. As another illustration in the case of a particle-based measurement sub-system 102, different measurement configurations may be associated with different landing energies of the particle illumination 114.

In some embodiments, a particular measurement sub-system 102 provides multiple types of measurements. Further, multiple measurement sub-systems 102 may be provided as a single tool or multiple tools. A single tool providing multiple measurement configurations is generally described in U.S. Pat. No. 7,933,026 issued on Apr. 26, 2011, which is incorporated herein by reference in its entirety. Multiple tool and structure analysis is generally described in U.S. Pat. No. 7,478,019 issued on Jan. 13, 2009, which is incorporated herein by reference in its entirety.

The metrology system 100 may be suitable for generating any type of metrology measurement on any type of test feature 104. Further, the metrology system 100 may generate multiple metrology measurements associated with various sub-features (e.g., critical parameters) associated with a test feature 104 and/or metrology measurements associated with multiple test features 104.

For example, the test feature 104 may be associated with any stage in a fabrication process such as, but not limited to, an etch process, a lithography process, or a deposition process. Non-limiting examples of a test feature 104 includes, but are not limited to, a patterned multi-layer structure, a patterned single-layer structure (e.g., a grating structure, or the like), a film stack (e.g., an unpatterned film stack), or a combination thereof. Further, non-limiting examples of a metrology measurements include, but are not limited to, a CD measurement, a height measurement (e.g., a height of a patterned feature, a height of a multi-layer feature, or the like), an overlay measurement, a film thickness, or a material property measurement (e.g., a refractive index measurement, a spectroscopic measurement, or the like).

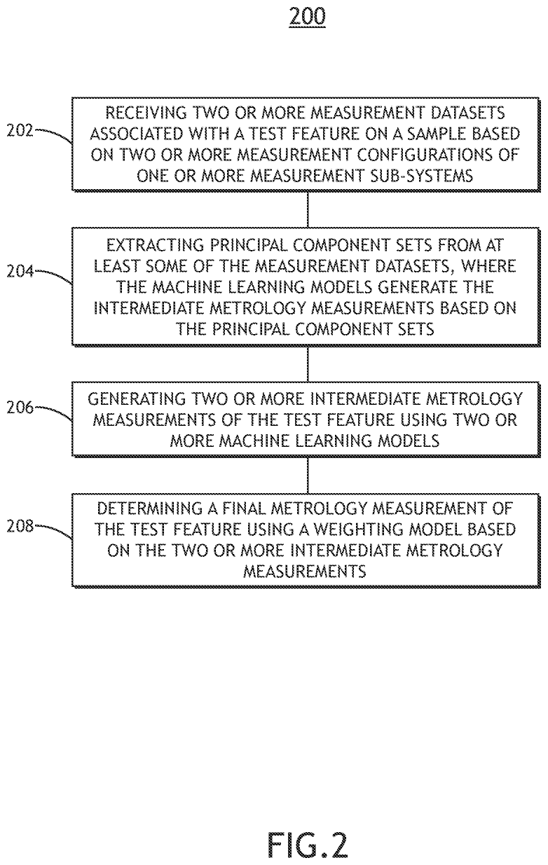

FIG. 2 is a flow diagram depicting steps performed in a metrology method 200, in accordance with one or more embodiments of the present disclosure. The embodiments and enabling technologies described herein in the context of the metrology system 100 should be interpreted to extend to the method 200. For example, the one or more processors 110 of the controller 108 may implement program instructions (e.g., stored on the memory 112) causing the processors 110 to implement any of the steps of the method 200 directly or indirectly. However, the method 200 is not limited to the architecture of the metrology system 100. In this way, examples of the implementation of the method 200 herein are merely illustrative and should not be interpreted as limiting the scope of the present disclosure.

In some embodiments, the method 200 includes a step 202 of receiving two or more measurement datasets associated with a test feature 104 on a sample 106 based on two or more measurement configurations of one or more measurement sub-systems 102. For example, a respective one the two or more measurement datasets may be generated with a respective one of two or more measurement configurations. As described with respect to the metrology system 100, the different measurement configurations may be associated with different measurement sub-systems 102 and/or different operational parameters of any number of measurement sub-systems 102. For instance, different measurement datasets may be generated using multiple angles of incidence (e.g., altitude and/or azimuth angles of incidence) of illumination 114 with a test feature 104.

In some embodiments, the method 200 includes a step 204 of generating two or more intermediate metrology measurements of the test feature 104 using two or more machine learning models. In this way, the two or more machine learning models may operate in parallel, though this is not a requirement and these machine learning models may generally operate simultaneously or sequentially on any processors 110. For example, a respective one of the two or more intermediate metrology measurements may be generated using at least a portion of a respective one of the two or more measurement datasets as an input to a respective one of the two or more machine learning models.

The machine learning models may incorporate any type or combination of machine learning techniques such as, but not limited to, supervised machine learning techniques, semi-supervised machine learning techniques, reinforcement machine learning techniques, or unsupervised machine learning techniques. As an illustration, a machine learning model may include, is not limited to, a linear model, a neural network model, a polynomial model, a decision tree model, or a random forest model. Further, the two or more machine learning models associated with step 204 may utilize common machine learning techniques (e.g., may have a common architecture) or may utilize different techniques. In this way, each machine learning model may be tailored based on the associated input data.

The machine learning models may accept any type of input data suitable for determining intermediate metrology measurements.

For example, a particular machine learning model may accept a measurement dataset (e.g., raw data) associated with a particular measurement configuration. As an illustration, a spectrometry-based optical measurement sub-system 102 may generate signals associated with 15 Mueller matrix elements, with approximately 670 wavelength pixels per signal to provide approximately 10,000 individual signals for a particular measurement configuration. This is merely illustrative, however, and should not be interpreted as limiting the scope of the present disclosure. For example, such a system may generate signals associated with any number of Mueller matrix elements (e.g., up to 16 Mueller matrix elements) and provide any number of datapoints for any number of wavelengths. Further, as described above, the method 200 is not limited to optical measurement sub-systems 102.

As another example, a particular machine learning model may accept principal components (PCs) associated with a subset or a transformation of a measurement dataset associated with a particular measurement configuration. In some embodiments, the method 200 includes a step 206 of extracting principal component sets (e.g., features) from at least some of the measurement datasets, where the machine learning models generate the intermediate metrology measurements based on the principal component sets. In this way, the step 206 of extracting the principal component sets from the measurement datasets may provide dimensionality reduction of the associated measurement datasets. The principal component sets may correspond to a subset of the measurement datasets or a transformation of the measurement datasets. The step 206 of extracting the principal component sets from the measurement datasets may be implemented using any suitable technique including, but not limited to, a principal component analysis (PCA) (e.g., linear or non-linear) or a fast Fourier Transform (FFT) analysis. In a general sense, the principal component sets may correspond to aspects of the associated measurement dataset that are correlated with the intermediate metrology measurements. Further, it is contemplated herein that generating a separate principal component set for each measurement dataset may, as opposed to generating a single principal component set for all available measurement datasets, may facilitate the development of data efficient and robust machine learning models.

In some embodiments, the method 200 includes a step 208 of determining a final metrology measurement of the test feature 104 using a weighting model based on the two or more intermediate metrology measurements. The weighting model may generate a final metrology measurement based on the combination of the intermediate metrology measurements generated in step 204. For example, the weighting model may generate the final metrology measurement as an average or weighted average of the intermediate metrology measurements. As another example, the weighting model may include an additional machine learning model to generate the final metrology measurement based on the intermediate metrology measurements. This additional machine learning model may utilize any type or combination of machine learning techniques such as, but not limited to, supervised machine learning techniques, semi-supervised machine learning techniques, reinforcement machine learning techniques, or unsupervised machine learning techniques. Further, the additional machine learning model may use common machine learning techniques as any of the machine learning models associated with step 204 or a different machine learning technique. Additionally, the weighting model may utilize a similar cost function as any of the machine learning models associated with step 204 or a custom cost function. As an illustration, the weighting model may seek to optimize (e.g., within a selected tolerance) a correlation between blind training data and known values of a metrology measurement. As another illustration, the weighting model may weight the intermediate metrology measurements to provide high accuracy, robustness, precision, tool-to-tool matching, or the like.

It is further contemplated herein that the weighting model may be tuned or otherwise adjusted (e.g., at regular intervals, in response to process deviations, or in response to any trigger) without requiring the retraining of the machine learning models associated with step 204.

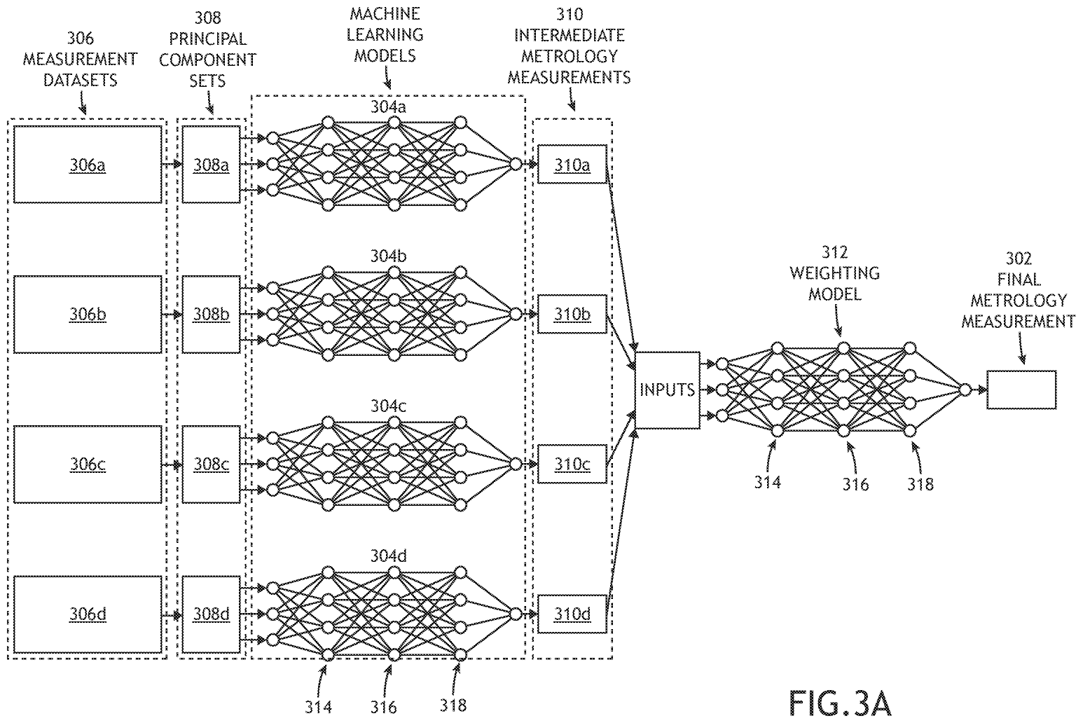

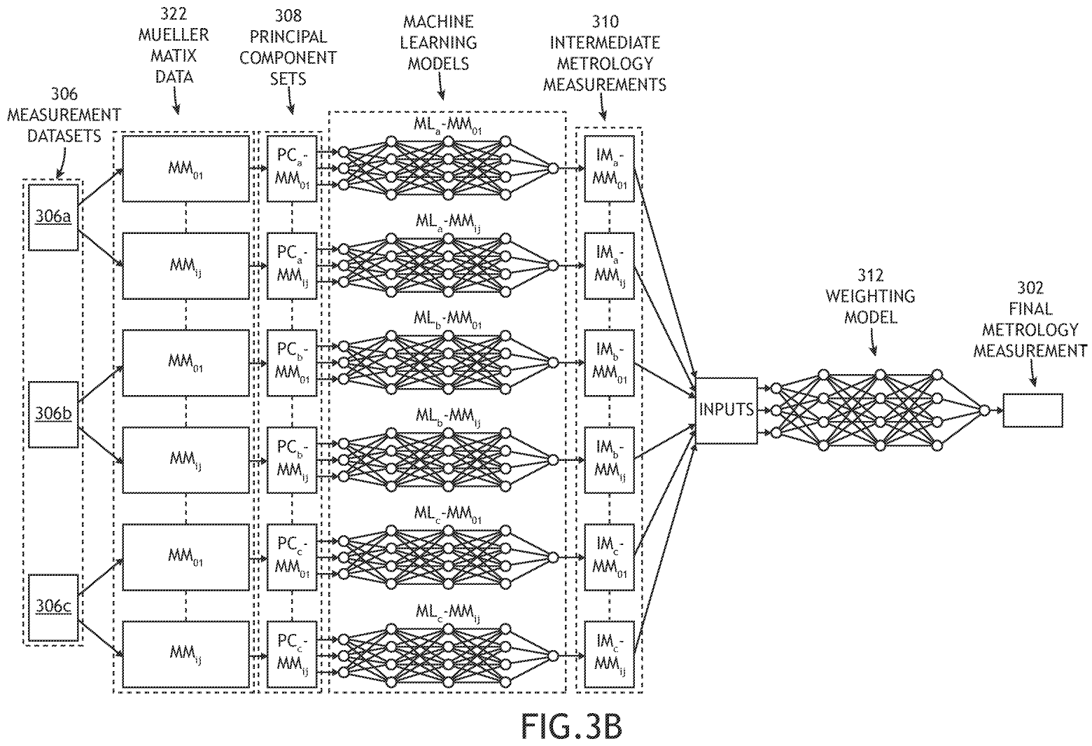

Referring now to FIGS. 3A and 3B, various architectures utilizing parallel machine learning models are described in greater detail, in accordance with one or more embodiments of the present disclosure.

In a general sense, any number of machine learning models may be developed based on associated measurement datasets, or data derived therefrom.

FIG. 3A is a schematic diagram depicting the generation of a final metrology measurement 302 based on separate machine learning models 304 (labeled as machine learning models 304a-304d) for different measurement datasets 306 (labeled as measurement datasets 306a-306d), in accordance with one or more embodiments of the present disclosure. In this configuration, any number N of measurement datasets 306 may be considered and the same number N of machine learning models 304 may be generated such that each machine learning model 304 is associated with a single measurement dataset 306.

FIG. 3A depicts a configuration including four measurement datasets 306, where each of the measurement datasets 306 is associated with a different measurement configuration of one or more measurement sub-systems 102. However, any number of measurement datasets 306 may be used. FIG. 3A further depicts a configuration including principal component layers configured to generate principal component sets 308 associated with transformations of the associated measurement datasets 306 (e.g., in step 206 of the method 200). In this configuration, the machine learning models 304 generate intermediate metrology measurements 310 (labeled as 310a-310d) based on the principal component sets 308 (labeled as 308a-308d).

A weighting model 312 then accepts the intermediate metrology measurements 310 as inputs and generates the final metrology measurement 302 as an output. In some embodiments, though not explicitly shown, the weighting model 312 may include another principal component layer to generate principal components based on the intermediate metrology measurements 310, which may be provided to the weighting model 312 as inputs. Such a configuration may allow for further optimization of the inputs to the weighting model 312.

In this figure, the machine learning models 304 and the weighting model 312 are depicted as neural networks with a common input layer 314, hidden layers 316, and an output layer 318. Further, all of the machine learning models 304 are depicted with the same schematic of these layers. However, this is merely illustrative and should not be interpreted as limiting the scope of the present disclosure. As described previously herein, the machine learning models 304 may utilize any type of architecture.

FIG. 3B is a schematic diagram depicting the generation of a final metrology measurement 302 based on separate machine learning models 304 for different Mueller matrix elements associated with different measurement datasets 306, in accordance with one or more embodiments of the present disclosure. Such a configuration may be suitable for applications in which at least one measurement dataset 306 is generated with a measurement sub-system 102 providing data indicative of Mueller matrix elements associated with the test feature 104, either alone or in combination. For example, various optical spectroscopic measurement sub-systems 102 may provide Mueller matrix data.

In particular, FIG. 3B depicts a configuration in which three measurement datasets 306 (labeled as measurement dataset 306a through measurement dataset 306c) associated with three different measurement configurations each provide Mueller matrix data 322 associated with specific Mueller matrix elements. For example, each Mueller matrix data 322 is labeled in FIG. 3B as MM₀₁-MMᵢⱼ, where i and j are integers in a range of 1-4 and represent the 16 possible Mueller matrix elements. As an illustration, an application including N measurement datasets 306 providing Mueller matrix data 322 for the full set of Mueller matrix elements may utilize up to M=16×N machine learning models 304.

As a result, each machine learning model 304 may be trained and optimized to generate intermediate metrology measurements based on Mueller matrix data 322 for particular Mueller matrix elements from a particular measurement dataset 306 associated with a particular measurement configuration. In FIG. 3B, the machine learning models 304 are labeled as MLₓ-MMᵢⱼ, where subscript x refers to the associated measurement dataset 306a-306c, and where subscripts ij reference the associated Mueller matrix element.

In some embodiments, as depicted in FIG. 3B, a principal component layer is used to generate principal components 314 associated with Mueller matrix data 322 for each Mueller matrix element, which may be provided as inputs to the machine learning models 304. In FIG. 3B, the principal components 314 are labeled as PCₓ-MMᵢⱼ, where subscript x refers to the associated measurement dataset 306a-306c, and where subscripts ij reference the associated Mueller matrix element. However, this is not a requirement and raw Mueller matrix data 322 for one or more Mueller matrix elements may be provided to associated machine learning models 304 as inputs for some applications.

Further, although FIG. 3B depicts separate machine learning models 304 associated with each Mueller matrix element, this is not a requirement. In a general sense, a machine learning model 304 may be generated for any selected number of Mueller matrix elements for any particular measurement dataset 306. In some embodiments, a machine learning model 304 is generated for a combination (e.g., a linear combination) of Mueller matrix data 322 associated with two or more Mueller matrix elements. Such data (or principal components thereof) may then be provided as input to the associated machine learning model 304.

It is contemplated herein that providing separate machine learning models 304 for individual Mueller matrix elements (or combinations thereof) as measured from separate measurement configurations may further limit uncontrolled correlations between inputs and outputs of the machine learning models 304 and may thus facilitate data efficient and robust metrology measurements.

In FIG. 3B, the weighting model 312 accepts the intermediate metrology measurements (or principal components thereof) from the various machine learning models 304 and generates a final metrology measurement. The descriptions of the weighting model 312 previously herein may be extended to FIG. 3B.

Referring generally to FIGS. 3A and 3B, any of the machine learning models 304 may be separately trained and optimized using any suitable technique. For example, training data may include measurement datasets associated with known variations of the test feature 104 along with known values of the metrology measurement of interest. As an illustration, a design of experiments (DOE) may be performed in which the test feature 104 is fabricated with the known variations and reference metrology measurements are captured with one or more reference metrology tools such as, but not limited to, a transmission electron microscope (TEM), a critical dimension scanning electron microscope (CD-SEM), or an atomic force microscope (AFM). As another example, training data may include simulated measurement datasets associated with simulated variations of the test feature 104 along with simulated values of the metrology measurement of interest. Any type of simulation may be utilized. As an illustration, electromagnetic simulations such as, but not limited to, RCWA techniques, finite element method (FEM) techniques, method of moments techniques, surface integral techniques, volume integral techniques, finite different time domain (FDTD) techniques, or the like. In some applications, training data may include a combination of experimental and simulated data.

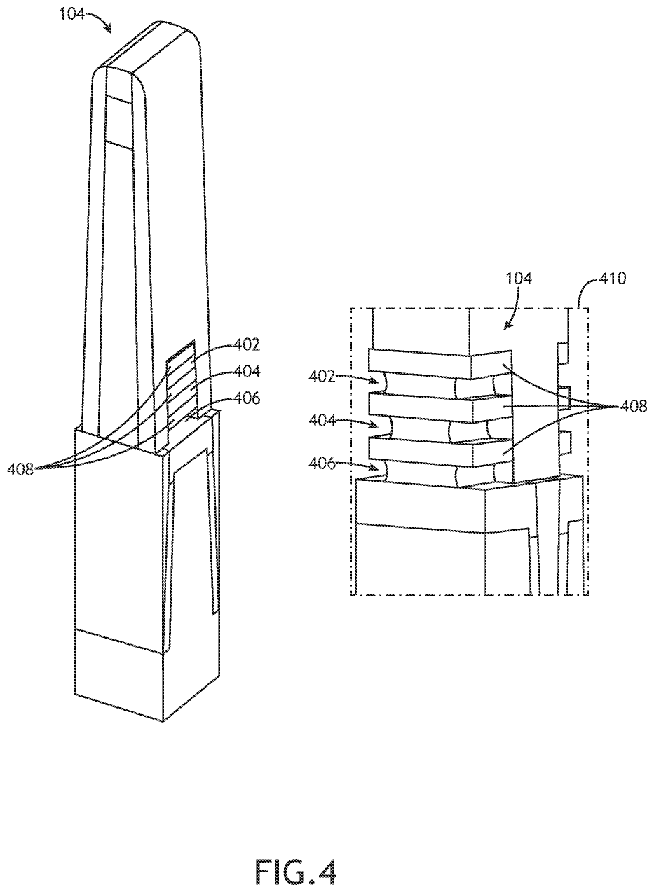

Referring now to FIGS. 4-6C, an example implementation of the method 200 is described, in accordance with one or more embodiments of the present disclosure.

FIG. 4 is a perspective view of a test feature 104 of a gate-all-around (GAA) recess structure, in accordance with one or more embodiments of the present disclosure. Three parameters of interest of such a test feature 104 include a top indent 402, a middle indent 404, and a bottom indent 406 associated with recesses of SiGe between silicon nanosheets 408. These features are further highlighted in the inset 410. It is contemplated herein that the complex three-dimensional geometry of such a test feature 104 with geometrically and optically buried structures of interest may be challenging or impractical for typical metrology techniques.

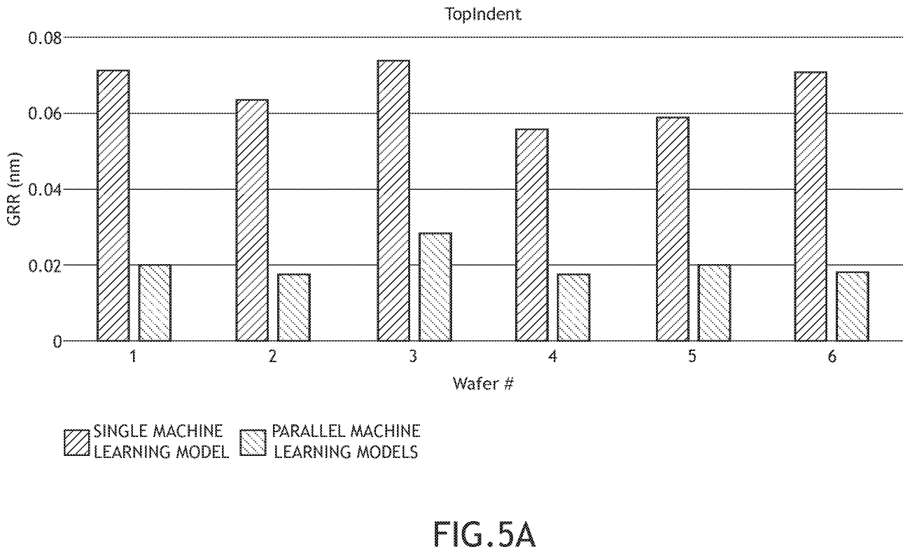

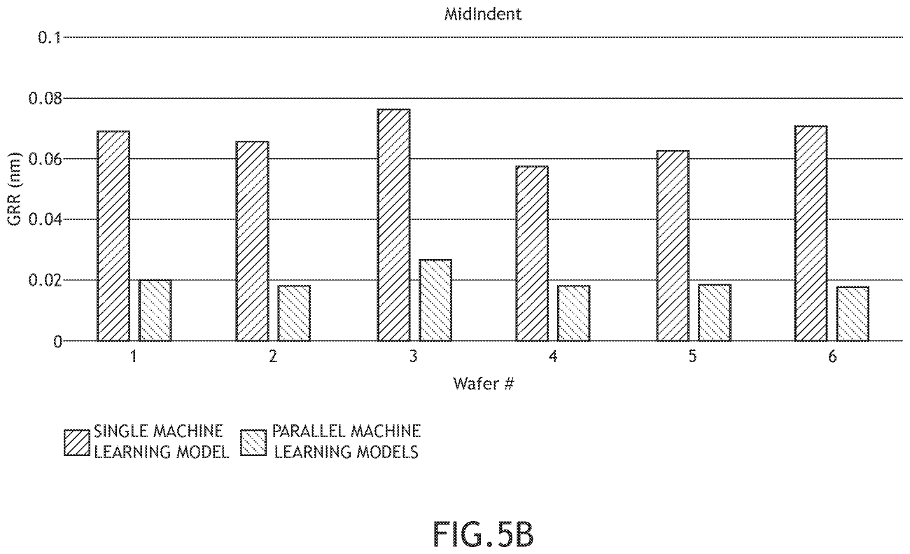

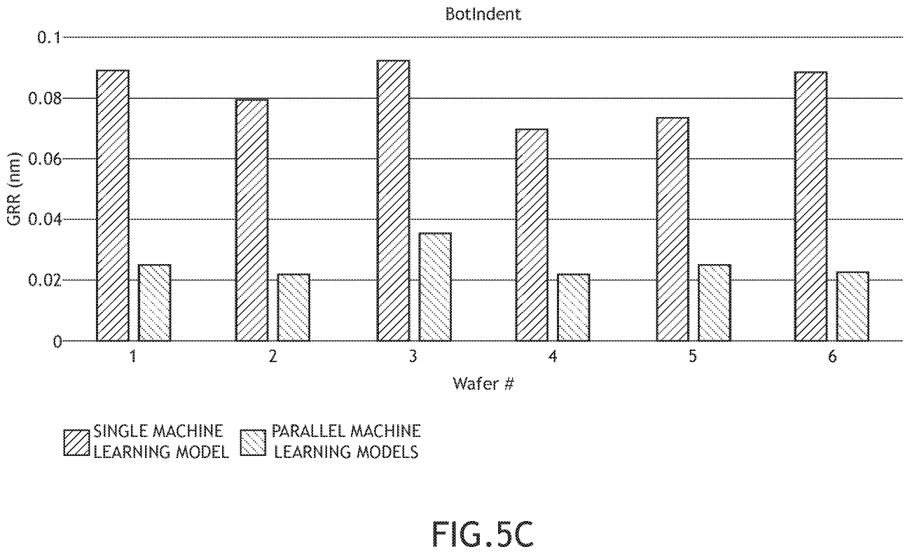

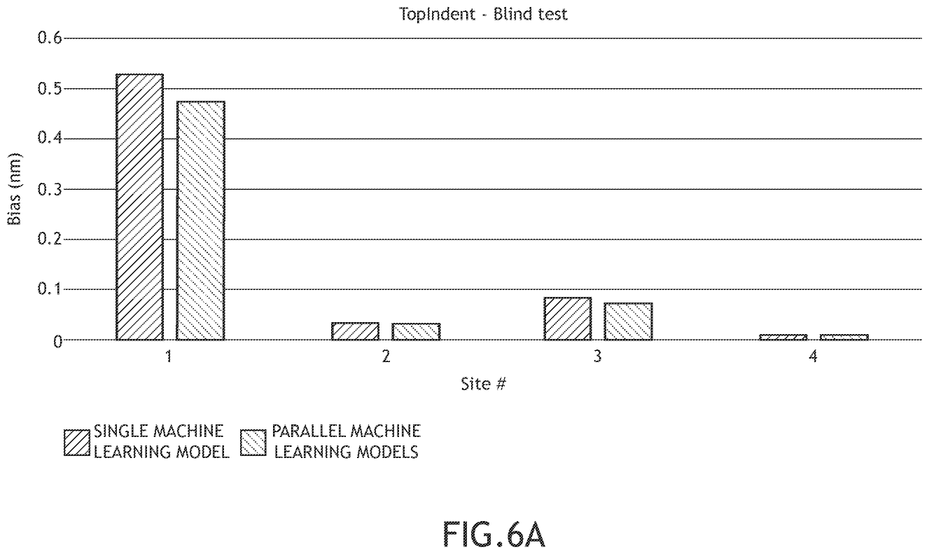

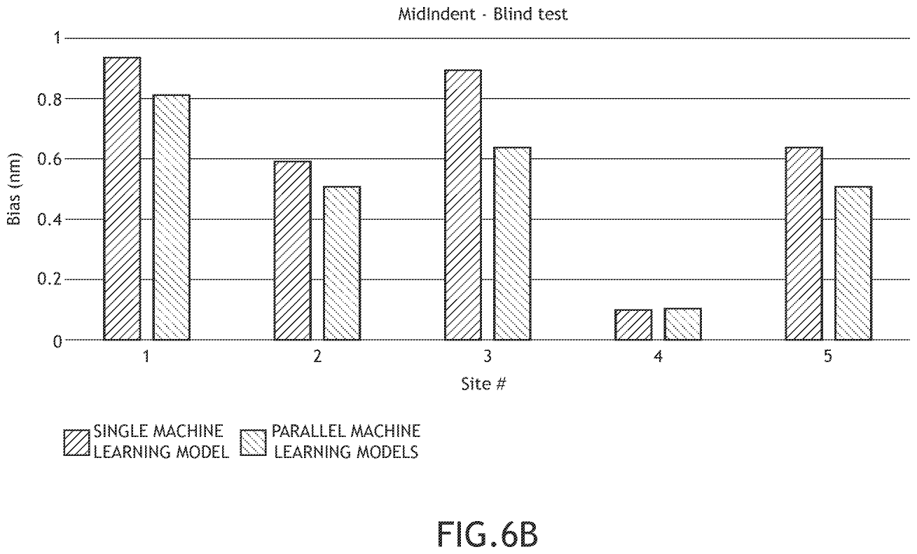

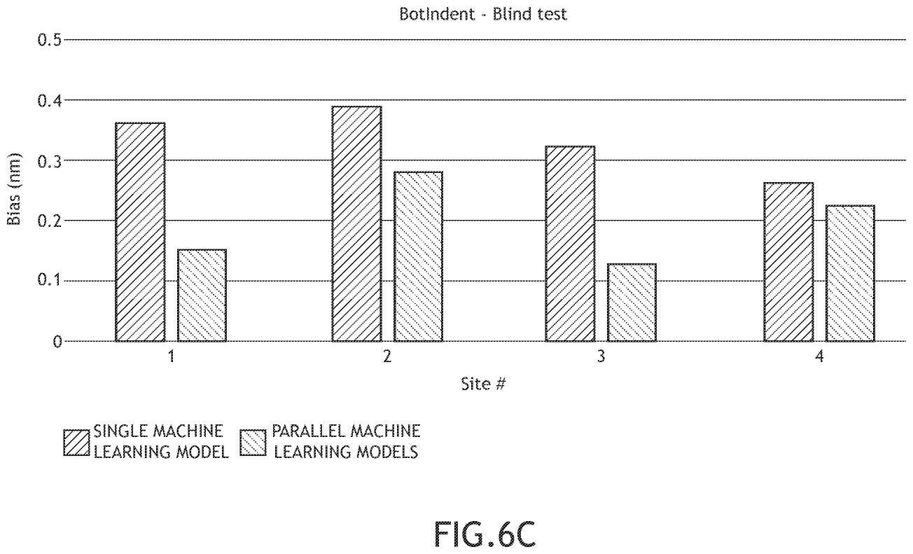

FIGS. 5A-6C depict plots comparing the performance of the method 200 with an alternative technique utilizing a single machine learning model. The data shown in FIGS. 5A-6C associated with the method 200 (labeled as “parallel machine learning techniques” is generated with a configuration as depicted in FIG. 3A utilizing four measurement datasets 306 associated with four measurement configurations. In particular, three of the four measurement datasets 306 are generated using a spectroscopic ellipsometer measurement sub-system 102 with rotating illumination and collection compensators (e.g. RCRC mode) at three different angles of incidence (59 degrees, 65 degrees, and 71 degrees). A fourth measurement dataset 306 was associated with a LSDR measurement dataset 306. Further, as depicted in FIG. 3A, principal component sets 308 are generated for each of the measurement datasets 306, which are provided as inputs to the machine learning models 304. The weighting model 312 for this experimental data is a simple average of the intermediate metrology measurements 310 generated by the associated machine learning models 304.

The data shown in FIGS. 5A-6C associated with a single machine learning model technique utilizes a single machine learning model that accepts principal components generated from a combination of the same four measurement datasets 306 and directly generates a single output metrology measurement.

FIG. 5A is a plot of gage repeatability and reproducibility (GRR) associated with metrology measurements of the top indent 402 of the test feature 104 in FIG. 4, in accordance with one or more embodiments of the present disclosure. FIG. 5B is a plot of gage repeatability and reproducibility (GRR) associated with metrology measurements of the middle indent 404 of the test feature 104 in FIG. 4, in accordance with one or more embodiments of the present disclosure. FIG. 5C is a plot of gage repeatability and reproducibility (GRR) associated with metrology measurements of the bottom indent 406 of the test feature 104 in FIG. 4, in accordance with one or more embodiments of the present disclosure. Together, FIGS. 5A-5C demonstrate at least a 3.5× improvement in GRR using the method 200 with multiple parallel machine learning models 304 relative to a technique using a single machine learning model with the same input data. FIGS. 5A-5C thus demonstrate high repeatability when generating a final metrology measurement 302.

FIG. 6A is a plot of blind test bias associated with metrology measurements of the top indent 402 of the test feature 104 in FIG. 4, in accordance with one or more embodiments of the present disclosure. FIG. 6B is a plot of blind test bias associated with metrology measurements of the middle indent 404 of the test feature 104 in FIG. 4, in accordance with one or more embodiments of the present disclosure. FIG. 6C is a plot of blind test bias associated with metrology measurements of the bottom indent 406 of the test feature 104 in FIG. 4, in accordance with one or more embodiments of the present disclosure. In particular, the bias values in FIGS. 6A-6C correspond to differences between a known value of the metrology measurement (e.g., as generated using a reference tool) and a measured value generated using the respective technique. Together, FIGS. 6A-6C demonstrate substantially reduced bias for all three features of interest and thus higher accuracy.

Referring now to FIGS. 1A-1D, additional aspects of the metrology system 100 are described in greater detail, in accordance with one or more embodiments of the present disclosure.

The one or more processors 110 of a controller 108 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 110 may include any device configured to execute algorithms and/or instructions (e.g., program instructions stored in memory). In some embodiments, the one or more processors 110 may be embodied as a desktop computer, mainframe computer system, workstation, image computer, parallel processor, networked computer, or any other computer system configured to execute a program configured to operate or operate in conjunction with the measurement sub-systems 102, as described throughout the present disclosure. Moreover, different subsystems of the metrology system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 108 may include one or more controllers housed in a common housing or within multiple housings. In this way, any controller or combination of controllers may be separately packaged as a module suitable for integration into metrology system 100.

The memory 112 may include any storage medium known in the art suitable for storing program instructions executable by the associated one or more processors 110. For example, the memory 112 may include a non-transitory memory medium. By way of another example, the memory 112 may include, but is not limited to, a read-only memory (ROM), a random-access memory (RAM), a magnetic or optical memory device (e.g., disk), a magnetic tape, a solid-state drive and the like. It is further noted that the memory 112 may be housed in a common controller housing with the one or more processors 110. In some embodiments, the memory 112 may be located remotely with respect to the physical location of the one or more processors 110 and the controller 108. For instance, the one or more processors 110 of the controller 108 may access a remote memory (e.g., server), accessible through a network (e.g., internet, intranet and the like).

FIGS. 1B-1D depict variations of an measurement sub-systems 102, in accordance with one or more embodiments of the present disclosure.

FIG. 1B is a simplified schematic of an optical measurement sub-system 102, in accordance with one or more embodiments of the present disclosure. For example, the measurement sub-systems 102 may include, but is not limited to, a spectroscopic ellipsometer (SE), an SE with multiple angles of illumination, an SE measuring Mueller matrix elements (e.g. using rotating compensator(s)), a single-wavelength ellipsometer, a beam profile ellipsometer (angle-resolved ellipsometer), a beam profile reflectometer (angle-resolved reflectometer), a broadband reflective spectrometer (spectroscopic reflectometer), a single-wavelength reflectometer, an angle-resolved reflectometer, an imaging system, a scatterometer (e.g., speckle analyzer), or any combination thereof.

In some embodiments, the measurement sub-systems 102 includes an illumination source 118 configured to generate illumination 114 in the form of at least one illumination beam. The illumination 114 from the illumination source 118 may include one or more selected wavelengths of light including, but not limited to, ultraviolet (UV) radiation, visible radiation, or infrared (IR) radiation. Further, the spatial profile of the illumination 114 on the sample 106 may be controlled by a field-plane stop to have any selected spatial profile.

The illumination source 118 may include any type of illumination source suitable for providing illumination 114 formed from light. In some embodiments, the illumination source 118 is a laser source. For example, the illumination source 118 may include, but is not limited to, one or more narrowband laser sources, a broadband laser source, a supercontinuum laser source, a white light laser source, or the like. In some embodiments, the illumination source 118 includes a laser-sustained plasma (LSP) source. For example, the illumination source 118 may include, but is not limited to, a LSP lamp, a LSP bulb, or a LSP chamber suitable for containing one or more elements that, when excited by a laser source into a plasma state, may emit broadband illumination. In some embodiments, the illumination source 118 includes a lamp source. In some embodiments, the illumination source 118 may include, but is not limited to, an arc lamp, a discharge lamp, an electrode-less lamp, or the like.

The illumination source 118 may provide the illumination 114 using free-space techniques and/or optical fibers.

In some embodiments, the measurement sub-systems 102 directs the illumination 114 to the sample 106 through at least one illumination lens 120 (e.g., an objective lens) via an illumination pathway 122. The illumination pathway 122 may include one or more optical components suitable for modifying and/or conditioning the illumination 114 as well as directing the illumination 114 to the sample 106. In some embodiments, the illumination pathway 122 includes one or more illumination-pathway optics 124 to shape or otherwise control the illumination 114. For example, the illumination-pathway optics 124 may include, but are not limited to, one or more field stops, one or more pupil stops, one or more polarizers, one or more filters, one or more beam splitters, one or more diffusers, one or more homogenizers, one or more apodizers, one or more beam shapers, or one or more mirrors (e.g., static mirrors, translatable mirrors, scanning mirrors, or the like).

The measurement sub-systems 102 may position the sample 106 for a measurement using any suitable technique. In some embodiments, as illustrated in FIG. 1B, the measurement sub-systems 102 includes a sample stage 126 including one or more actuators (e.g., linear actuators, tip/tilt actuators, rotational actuators, or the like) to position the sample 106 with respect to the illumination beam. In some embodiments, though not explicitly shown, the measurement sub-systems 102 includes beam-scanning optics (e.g., galvanometer mirrors, scanning prisms, or the like) to adjust a position and/or scan one or more beams of illumination 114.

In some embodiments, the measurement sub-systems 102 includes at least one collection lens 128 to capture collection signal 116 (e.g., light), and direct this collection signal 116 to one or more detectors 130 through a collection pathway 132. The collection pathway 132 may include one or more optical elements suitable for modifying and/or conditioning the collection signal 116 from the sample 106. In some embodiments, the collection pathway 132 includes one or more collection-pathway optics 134 to shape or otherwise control the collection signal 116. For example, the collection-pathway optics 134 may include, but are not limited to, one or more field stops, one or more pupil stops, one or more polarizers, one or more filters, one or more beam splitters, one or more diffusers, one or more homogenizers, one or more apodizers, one or more beam shapers, or one or more mirrors (e.g., static mirrors, translatable mirrors, scanning mirrors, or the like).

The measurement sub-systems 102 may generally include any number or type of detectors 130. For example, the measurement sub-systems 102 may include at least one single-pixel detector 130 such as, but not limited to, a photodiode, an avalanche photodiodes, or a single-photon detectors. As another example, the measurement sub-systems 102 may include at least one mutli-pixel detector 130 such as, but not limited to, a charge-coupled device (CCD) or a complementary metal-oxide semiconductor (CMOS) device, a line detector, or a time-delay integration (TDI) detector.

A detector 130 may be located at any selected location within the collection pathway 132. In some embodiments, the measurement sub-systems 102 includes a detector 130 at a field plane (e.g., a plane conjugate to the sample 106) to generate an image of the sample 106. In some embodiments, the measurement sub-systems 102 includes a detector 130 at a pupil plane (e.g., a diffraction plane) to generate a pupil image. In this regard, the pupil image may correspond to an angular distribution of light from the sample 106 detector 130. For instance, diffraction orders associated with diffraction of the illumination 114 from the sample 106 may be imaged or otherwise observed in the pupil plane. In a general sense, a detector 130 may capture any combination of reflected (or transmitted), scattered, or diffracted light from the sample 106.

The illumination pathway 122 and the collection pathway 132 of the measurement sub-systems 102 may be oriented in a wide range of configurations. For example, as illustrated in FIG. 1B, the illumination pathway 122 and the collection pathway 132 may contain non-overlapping optical paths. In some embodiments, though not explicitly shown, the measurement sub-systems 102 may include a beamsplitter oriented such that a common objective lens may simultaneously direct the illumination 114 to the sample 106 and capture collection signal 116.

FIG. 1C is a simplified schematic of an x-ray measurement sub-system 102, in accordance with one or more embodiments of the present disclosure. Such a measurement sub-systems 102 may be configured as, but is not limited to, a small-angle x-ray scatterometer (SAXR), or a soft x-ray reflectometer (SXR). X-ray characterization systems and associated measurement techniques are generally described in U.S. Pat. No. 7,929,667 issued on Apr. 19, 2011; U.S. Pat. No. 9,885,962 issued on Feb. 6, 2018; U.S. Pat. No. 10,013,518 issued on Jul. 3, 2018; U.S. Pat. No. 10,324,050 issued on Jun. 18, 2019; U.S. Pat. No. 10,352,695 issued on Jul. 16, 2019; U.S. Pat. No. 10,775,323 issued on Sep. 15, 2020; Germer, et al., “Intercomparison between optical and x-ray scatterometry measurements of FinFET structures” Proc. SPIE, v.8681, p. 86810Q (2013); Kline, et al. “X-ray scattering critical dimensional metrology using a compact x-ray source for next generation semiconductor devices.” Journal of Micro/Nanolithography, MEMS, and MOEMS 16.1 (2017); U.S. Pat. No. 11,333,621 issued on May 17, 2022; and U.S. Patent Application No. 2021/0207956 published on Jul. 8, 2021; all of which are incorporated herein by reference in their entireties.

In some embodiments, the illumination source 118 is an x-ray source configured to generate x-ray illumination 114 having any particle energies (e.g., soft x-rays, hard x-rays, or the like). The measurement sub-systems 102 may then include any combination of components suitable for capturing an associated collection signal 116, which may include, but is not limited to, x-ray emissions, optical emissions, or particle emissions.

For example, the measurement sub-systems 102 may include at least one x-ray illumination lens 120 and/or illumination-pathway optics 124 suitable for collimating or focusing x-ray illumination 114. Although not shown, the measurement sub-system 102 may further include at least one x-ray collection pathway lens and/or collection-pathway optics suitable for collecting, collimating, and/or focusing the collection signal 116 from the sample 106. Further, the measurement sub-systems 102 may include various illumination-pathway optics 124 and/or collection-pathway optics 134 such as, but not limited to, x-ray collimating mirrors, specular x-ray optics such as grazing incidence ellipsoidal mirrors, polycapillary optics such as hollow capillary x-ray waveguides, multilayer optics, or systems, or any combination thereof. In embodiments, the measurement sub-systems 102 includes an x-ray detector 130 such as, but not limited to, an x-ray monochromator (e.g., a crystal monochromator such as a Loxley-Tanner-Bowen monochromator, or the like), x-ray apertures, x-ray beam stops, or diffractive optics (e.g., such as zone plates).

FIG. 1D is a simplified schematic of a particle beam measurement sub-system 102, in accordance with one or more embodiments of the present disclosure.

In some embodiments, the illumination source 118 includes a particle source (e.g., an electron beam source, an ion beam source, or the like) such that the illumination 114 includes a particle beam (e.g., an electron beam, a particle beam, or the like). The illumination source 118 may include any particle source known in the art suitable for generating particle illumination 114. For example, the illumination source 118 may include, but is not limited to, an electron gun or an ion gun. In some embodiments, the illumination source 118 is configured to provide a particle beam with a tunable energy. For example, an illumination source 118 including an electron source may, but is not limited to, provide an accelerating voltage in the range of 0.1 kV to 30 kV. As another example, an illumination source 118 including an ion source may, but is not required to, provide an ion beam with an energy in the range of 1 to 50 keV.

In some embodiments, the measurement sub-system 102 includes one or more particle focusing elements. For example, the one or more particle focusing elements may include, but are not limited to, a single particle focusing element or one or more particle focusing elements forming a compound system. In some embodiments, the one or more particle focusing elements include illumination lens 120 configured to direct the particle illumination beam to the sample 106. Further, the one or more particle focusing elements may include any type of electron lenses known in the art including, but not limited to, electrostatic, magnetic, uni-potential, or double-potential lenses.

In some embodiments, the measurement sub-systems 102 includes one or more particle detectors 130 to image or otherwise detect particles emanating from the sample 106. For example, the detector 130 may include an electron collector (e.g., a secondary electron collector, a backscattered electron detector, or the like). As another example, the detector 130 may include a photon detector (e.g., a photodetector, an x-ray detector, a scintillating element coupled to photomultiplier tube (PMT) detector, or the like) for detecting electrons and/or photons from the sample surface.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A metrology system, comprising:
a controller including one or more processors configured to execute program instructions causing the one or more processors to implement a metrology recipe by:
receiving two or more measurement datasets associated with a test feature on a sample from one or more measurement sub-systems operable under two or more measurement configurations, wherein a respective one the two or more measurement datasets is generated with a respective one of the two or more measurement configurations;
generating two or more intermediate metrology measurements of the test feature using two or more machine learning models, wherein a respective one of the two or more intermediate metrology measurements is generated using at least a portion of a respective one of the two or more measurement datasets as an input to a respective one of the two or more machine learning models; and
determining a final metrology measurement of the test feature using a weighting model based on the two or more intermediate metrology measurements.

2. The metrology system of claim 1, wherein a respective one of the two or more machine learning models is associated with a single respective one of the two or more measurement datasets.

3. The metrology system of claim 1, wherein at least one of the two or more machine learning models is associated with a single Mueller matrix element and further associated with a single respective one of the two or more measurement datasets.

4. The metrology system of claim 1, wherein at least one of the two or more machine learning models is associated with a linear combination of two or more Mueller matrix elements and further associated with a single respective one of the two or more measurement datasets.

5. The metrology system of claim 1, wherein the program instructions are further configured to cause the one or more processors to implement the metrology recipe by extracting two or more principal component sets from the two or more measurement datasets, wherein a respective one of principal component sets corresponds to a subset of a respective one of the two or more measurement datasets, wherein generating the two or more intermediate metrology measurements of the test feature using two or more machine learning models comprises:
generating the two or more intermediate metrology measurements of the test feature using the two or more principal component sets as inputs to the two or more machine learning models, wherein a respective one of the two or more principal component sets is provided as an input to the respective one of the two or more machine learning models.

6. The metrology system of claim 5, wherein the two or more principal component sets are generated using at least one of a principal component analysis or a fast Fourier Transform.

7. The metrology system of claim 1, wherein at least one of the two or more machine learning models comprises:
at least one of a linear model, a neural network model, a polynomial model, a decision tree model, or a random forest model.

8. The metrology system of claim 1, wherein the weighting model comprises:
at least one of an average of the two or more intermediate metrology measurements, a weighted average of the two or more intermediate metrology measurements, or a neural network model.

9. The metrology system of claim 1, wherein the program instructions are further configured to cause the one or more processors to train the two or more machine learning models with training data.

10. The metrology system of claim 9, wherein the training data comprises:
at least one of simulated datasets or measurement datasets generated on one or more training samples with known parameters of the test feature.

11. The metrology system of claim 1, wherein the one or more measurement sub-systems comprise:
at least one of a spectroscopic ellipsometer, a single-wavelength ellipsometer, an angle-resolved ellipsometer, an angle-resolved reflectometer, a spectroscopic reflectometer, a single-wavelength reflectometer, a Raman metrology tool, a laser dispersion spectroscopic reflectometry tool, a spectroscopic photoreflectance tool, a spectroscopic photoluminescence tool, an x-ray metrology tool, or a particle-based metrology tool.

12. The metrology system of claim 1, wherein at least one of the two or more measurement datasets comprises:
spectroscopic measurement data.

13. The metrology system of claim 1, wherein the two or more measurement configurations comprise:
two or more illumination angles.

14. The metrology system of claim 13, wherein the two or more illumination angles comprise:
two or more altitude illumination angles.

15. The metrology system of claim 13, wherein the two or more illumination angles comprise:
two or more azimuth illumination angles.

16. The metrology system of claim 1, wherein the final metrology measurement comprises:
to at least one of a critical dimension (CD) measurement, a height measurement, an overlay measurement, a film thickness, or a material property.

17. The metrology system of claim 1, wherein the test feature comprises:
at least one of a patterned single-layer structure, a patterned multi-layer structure or a film stack.

18. The metrology system of claim 1, wherein the test feature comprises:
two or more sub-features, wherein the final metrology measurement includes measurements of the two or more sub-features.

19. The metrology system of claim 1, wherein the test feature is associated with at least one of an etch process, a lithography process, or a deposition process.

20. A metrology system, comprising:
one or more measurement sub-systems configured to operate under two or more measurement configurations; and
a controller including one or more processors configured to execute program instructions causing the one or more processors to implement a metrology recipe by:
receiving two or more measurement datasets associated with a test feature on a sample, wherein a respective one the two or more measurement datasets is generated with a respective one of the two or more measurement configurations;
generating two or more intermediate metrology measurements of the test feature using two or more machine learning models, wherein a respective one of the two or more intermediate metrology measurements is generated using at least a portion of a respective one of the two or more measurement datasets as an input to a respective one of the two or more machine learning models; and
determining a final metrology measurement of the test feature using a weighting model based on the two or more intermediate metrology measurements.

21. The metrology system of claim 20, wherein the one or more measurement sub-systems comprise:
at least one of a spectroscopic ellipsometer, a single-wavelength ellipsometer, an angle-resolved ellipsometer, an angle-resolved reflectometer, a spectroscopic reflectometer, a single-wavelength reflectometer, a Raman metrology tool, a laser dispersion spectroscopic reflectometry tool, a spectroscopic photoreflectance tool, a spectroscopic photoluminescence tool, an x-ray metrology tool, or a particle-based metrology tool.

22. The metrology system of claim 20, wherein a respective one of the two or more machine learning models is associated with a single respective one of the two or more measurement datasets.

23. The metrology system of claim 20, wherein at least one of the two or more machine learning models is associated with a single Mueller matrix element and further associated with a single respective one of the two or more measurement datasets.

24. The metrology system of claim 20, wherein at least one of the two or more machine learning models is associated with a linear combination of two or more Mueller matrix elements and further associated with a single respective one of the two or more measurement datasets.

25. A metrology method, comprising:
receiving two or more measurement datasets associated with a test feature on a sample from one or more measurement sub-systems operable under two or more measurement configurations, wherein a respective one the two or more measurement datasets is generated with a respective one of the two or more measurement configurations;
generating two or more intermediate metrology measurements of the test feature using two or more machine learning models, wherein a respective one of the two or more intermediate metrology measurements is generated using at least a portion of a respective one of the two or more measurement datasets as an input to a respective one of the two or more machine learning models; and
determining a final metrology measurement of the test feature using a weighting model based on the two or more intermediate metrology measurements.
